(19) United States
(12) Patent Application Publication
(10) Pub. No.: US 2002/0092951 A1
(43) Pub. Date: Jul. 18, 2002

(54) Lock system for aircraft cockpit door

(76) Inventor: Asher Haviv, Be'er Yaakov (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(21) Appl. No.: 10/036,472

(22) Filed: Jan. 7, 2002

Related U.S. Application Data
(60) Provisional application No. 60/261,216, filed on Jan. 16, 2001.

(51) Int. Cl. B64D 11/00; B64D 13/00

(52) U.S. Cl. 244/118.5

(57) ABSTRACT

The present invention is a lock system particularly suited to the requirements of restricting access to an aircraft cockpit, although the invention may equally be applied to a range of other applications. Disclosed is a lock system including a door mounted locking bolt that may be actuated by a handle on the cockpit side of the door and by a key on the cabin side of the door. The key actuator may be disabled from the cockpit side of the door. The bolt is configured to engage a doorframe mounted bolt-receiver the bolt and the bolt-receiver thereby interlocking in a way that holds the bolt in the bolt-receiver in the advent of attempted forced entry to the cockpit, such as by a terrorist. The doorframe elements are further configured so as to automatically release the bolt and allow the door to open freely in the case of a sudden differential is cockpit and cabin air pressure. The automatic release may also be activated a manual switch or by a system override.

### FIELD AND BACKGROUND OF THE INVENTION

The present invention relates to lock systems and, in particular, it concerns a lock system suitable for use in the entrance to the cockpit of an aircraft.

The closest prior art to the present invention is believed to be intercom-operated systems with: key-operated manual lock from outside; handle-operated manual lock from inside; electric release from remote location. Existing systems of this type have a spring-biased latch-bolt which engages an electrically releasable hinged flap in the doorframe which is normally locked against hinged rotation.

Systems of this type are not suited to aircraft security applications for a number of reasons. Most importantly, safety regulations require that internal aircraft doors release themselves automatically in either direction under conditions of pressure differential corresponding to about 80 kgf, in order to avoid excessive internal pressure differentials which could lead to destruction of the aircraft. The aforementioned intercom-operated systems, however, can only open in one direction. Additional problems are posed by security requirements which exceed the specifications generally provided by intercom-operated systems. This is particularly true when the flexibility of lightweight aircraft doors is taken into consideration. Specifically, flexing of the door under forces applied during an attempted breaching could cause a conventional latch-bolt to escape from the doorframe.

There is therefore a need for a lock system that can withstand an attempted forced entry of up to 500 kgf, yet open automatically in either direction under conditions of pressure differential corresponding to about 80 kgf. It would be preferable for the lock system to further provide unrestricted manual egress and restricted manual ingress, i.e., use of a key to operate the ingress mechanism, the ingress mechanism being able to be disabled from the cockpit side of the door. Further preferable features include manual and electronic overridability.

### SUMMARY OF THE INVENTION

The present invention is a lock system suitable for use in the entrance to the cockpit of an aircraft.

According to the teachings of the present invention there is provided, a lockable doorway system, comprising: (a) a doorframe, having a height and a width; (b) a door, an edge of the door being hingedly connected to the doorframe; (c) a door mounted bolt mechanism including a displaceable locking bolt; and (d) a doorframe mounted bolt-receiver; wherein the bolt, and the bolt-receiver are configured such that in a locked state the bolt and the bolt-receiver are engaged, thereby interlocking the bolt in the bolt-receiver so as to retain the bolt in the bolt-receiver against forced removal of the bolt from the bolt-receiver along a vector away form the doorframe and toward the door, the vector being substantially parallel to the width.

According to a further teaching of the present invention, the bolt mechanism includes a spring biased rotatable disk, the rotatable disk having an axis that is substantially perpendicular to a plane of a surface of the door, with the bolt extending radially from the disk, whereby rotation of the disk, so as to bring the bolt to a disengaged position, is in a direction that further tensions the spring, and the bolt is displaceable along an arched path.

According to a further teaching of the present invention, the bolt includes an enlarged tip.

According to a further teaching of the present invention, the bolt-receiver includes a receiving slot configured to receive the bolt thereby trapping the enlarged tip.

According to a further teaching of the present invention, the bolt mechanism includes: a first bolt-actuator located on a first side of the door, the first bolt-actuator being deployed such that activation of the first bolt-actuator brings the bolt mechanism to an unlocked state; a second bolt-actuator located on a second side of the door; the second bolt-actuator being deployed such that activation of the second bolt-actuator brings the bolt mechanism to an unlocked state; and a disabling mechanism deployed so as to, when activated, disable the second-bolt-actuator, the disabling mechanism being accessible only from the first side of the door.

According to a further teaching of the present invention, the second bolt-actuator further includes a secondary-actuator mechanism that, when activated, engages the bolt mechanism.

According to a further teaching of the present invention, the bolt mechanism includes a latch mechanism whereby the displacement of the bolt may selectively be restricted.

According to a further teaching of the present invention, there is further provided a security bar that extends from the bolt mechanism to the hinged edge of the door, the security bar being anchored to the doorframe at a hinged side of the doorframe.

According to a further teaching of the present invention, the security bar includes hinges thereby being hingedly attached to the doorframe.

There is also provided according to the teachings of the present invention, a lockable doorway system, comprising: (a) a doorframe, having a height and a width; (b) a door, an edge of the door being hingedly connected to the doorframe so as to allow the door to open bi-directionally; (c) a door mounted bolt mechanism including a displaceable locking bolt; and (d) a doorframe mounted bolt-receiver having at least a first receiver-position wherein the bolt may be engaged, thereby holding the door in a locked position; the bolt-receiver being selectively releasable from the first receiver-position thereby allowing redeployment of the bolt-receiver so as to release the bolt thereby allowing the door to open in one of at least two modes, a first of the at least two modes allowing the door to open in one direction, a second of the at least two modes allowing the door to open in two directions; wherein the door may be opened by both the displacement of the bolt and the redeployment of the bolt-receiver, each of the displacement of the bolt and the redeployment of the bolt receiver independently opening the door.

According to a further teaching of the present invention, the redeployment of the bolt-receiver includes rotation of the bolt-receiver about an axis that is substantially parallel to the width.

There is also provided according to the teachings of the present invention, a lockable doorway system, comprising: (a) a doorframe, having a height and a width; (b) a door, an edge of the door being hingedly connected to the doorframe so as to allow the door to open bi-directionally; (c) a door mounted bolt mechanism including a displaceable locking bolt; (d) a doorframe mounted bolt-receiver, the bolt-receiver being mounted to the doorframe so as to be rotatable about an axis that is substantially parallel to the width, the bolt-receiver including at least a first receiver-position wherein the bolt may be engaged, thereby holding the door in a locked position; the bolt-receiver being selectively releasable from the first receiver-position thereby allowing redeployment of the bolt-receiver so as to release the bolt thereby allowing the door to open in one of at least two modes, a first of the at least two modes allowing the door to open in one direction, a second of the at least two modes allowing the door to open in two directions; and (e) a release system for the selective release of the bolt-receiver.

There is also provided according to the teachings of the present invention, a release system for selective release of a door from a locked position in a doorframe, the lock system comprising: (a) an abutment portion of an element that is displaceable along a predetermined path when the door is opened; and (b) a release mechanism deployed so as to retain the door in a locked state and when the release mechanism is activated the door is released from the locked state, the release mechanism including at least one rotatable element, the rotatable element having an axis of rotation, a cross-section of the rotatable element taken along a line substantially perpendicular to the axis of rotation is substantially circular, the rotatable element having at least two selectable deployment-positions including a first deployment-position wherein the axis of rotation of the rotatable element is within the displacement path of the abutment portion, thereby restricting the displacement of the abutment portion, and a second deployment-position wherein the axis of rotation of the rotatable element is outside the displacement path of the abutment portion, thereby allowing the displacement of the abutment portion.

According to a further teaching of the present invention, the abutment portion includes at least one from the following group: (a) an extension of a rotatable bolt-receiver; (b) the door; (c) an extension of the door; and (d) a displaceable lock bolt deployed in the door.

According to a further teaching of the present invention, the at least one rotatable element is implemented as at least two rotatable elements, deployment of a first of the at least two rotatable elements to its the second deployment-position allows displacement of the door element in a first direction, and deployment of a second of at least two rotatable elements to its the second deployment-position allows displacement of the door element in a second direction, the at least two rotatable elements being deployable individually or in combination.

According to a further teaching of the present invention, the release mechanism includes an electrically activated mechanism.

According to a further teaching of the present invention, the release mechanism includes at least one electromagnetic device for each of the rotatable elements such that each of the rotatable elements is deployed to any one of the deployment-positions by a corresponding the electromagnetic device.

According to a further teaching of the present invention, the electrical activation includes use of any devices, singularly and in combination, from a list including: (a) a manually operated switch; (b) a pressure monitoring system that monitors the atmospheric pressure on each side of the door; and (c) a system override switch.

### BRIEF DESCRIPTION OF THE DRAWINGS

The invention is herein described, by way of example only, with reference to the accompanying drawings, wherein:

FIG. 1 is a schematic plan view of the front portion of an aircraft illustrating the position of doors connecting to the cockpit;

FIG. 2 is a block diagram of the main elements of a lock system according to the teachings of the present invention;

FIG. 3 is a schematic isometric representation of the principle of operation of a preferred mechanical implementation of a lock mechanism for providing dual release operations;

FIG. 4 is a cross-sectional view taken in a plane parallel to the surface of a door showing a lock mechanism constructed and operative according to the teachings of the present invention in its normally-locked state;

FIG. 5 is a cross-sectional view similar to FIG. 4 showing the lock mechanism during manual opening;

FIG. 6A is a cross-sectional view taken along the line VI-VI of FIG. 4;

FIG. 6B is a cross-sectional view similar to FIG. 6A showing the lock mechanism immediately after being opened by remote electronic release;

FIG. 7 is a schematic view of an alternative implementation of the present invention employing an electromagnetic locking mechanism;

FIG. 8 is an isometric perspective view of a door-mounted component of a lock system constructed and operative according to the teachings of the present invention;

FIG. 9 is an isometric side view of the door-mounted component of FIG. 8, shown in its normally-locked state;

FIG. 10 is a cut-way schematic view of the door-mounted component of FIG. 8;

FIG. 11 is an isometric side view of the door-mounted component of FIG. 8, shown in its unlocked state;

FIG. 12 is an isometric side view of the door-mounted component of FIG. 8, shown in its continuously unlocked state;

FIG. 13a and FIG. 13b are schematic views of different preferred embodiments of security bars constructed and operative according to the teachings of the present invention;

FIG. 14 is an isometric perspective view of a door-frame mounted bolt-receiver constructed and operative according to the teachings of the present invention, in its locked state;

FIG. 15 is a schematic view of the rotatable elements of a release mechanism constructed and operative according to the teachings of the present invention.

FIG. 16 and FIG. 17 are isometric perspective views of the bolt-receiver of FIG. 14 in a single-directional unlocked state; and

FIG. 18 is an isometric perspective view of the bolt-receiver of FIG. 14 in a bi-directional unlocked state.

### DESCRIPTION OF THE PREFERRED EMBODIMENTS

The present invention is a lock system particularly suited to the requirements of restricting access to an aircraft cockpit, although the invention may equally be applied to a range of other applications.

The principles and operation of lock systems according to the present invention may be better understood with reference to the drawings and the accompanying description.

Referring now to the drawings, FIG. 1 shows an aircraft layout in which a cockpit 10 is divided from the passenger area 12 by a secure door 14. According to increasingly stringent security requirements, door 14 is preferably locked in a manner sufficient to secure it against forceful breaching by a terrorist, requiring a lock which can withstand up to about 500 kgf. This is rendered more problematic by the considerable flexibility of the lightweight door panels used, making a simple axially-moved bolt unreliable. At the same time, safety regulations require that the door must completely release itself under conditions of pressure differential across the door corresponding to a force of about 80 kgf on the door. This is necessary to avoid potentially catastrophic build-up of pressure differential between parts of the aircraft such as could otherwise occur as a result of cabin decompression at altitude.

According to additional precautions taken by certain airlines, a second door 16 is provided spaced from door 14. Door 16 allows implementation of additional precautions through which the pilot is never within sight of the passengers. Thus, prior to opening door 14 for any reason, door 16 is first closed. After door 14 is again closed, door 16 is returned to its normally-open state.

The lock system of the present invention is intended primarily for door 14, although it may additionally be used, either in its full implementation or in a simplified form, for door 16. When used for both doors, the system is preferably part of an integrated control system.

FIG. 2 illustrates the preferred functionality of a lock system, generally designated 20, constructed and operative according to the teachings of the present invention. The lock is preferably configured to be normally-locked such that, during normal operation, whenever the door is in its closed position it is automatically locked. The lock is then released (i.e., unlocked) through either an electronically actuated release mechanism 22 or a manually actuated release mechanism 24. Actuation of electronic release mechanism 22 is initiated by any of the following: an electric door release button 26 accessible to the pilot within the cockpit; a pressure differential sensor 28 which produces an emergency release signal if the pressure differential between the two sides of the door exceeds a predetermined value; and a system override control 30 used, for example, during ground maintenance of the aircraft when the security features are unnecessarily inconvenient. Actuation of manual release mechanism 24 is achieved either by operating a mechanical handle 32 on the side of the door facing the cockpit, or by use of a key 34 from outside the cockpit.

Optionally, manual release mechanism 24 and electronic release mechanism 22 may be combined such that manual or electronic actuation both trigger a single release mechanism. This is typically achieved by deploying an electric switch to be operated by movement of mechanical handle 32 and key 34.

In a first preferred implementation, manual release mechanism 24 and electronic release mechanism 22 are implemented as independent release mechanisms, thereby providing dual mechanisms either of which can be used to release the door. This adds to the safety characteristics of the system.

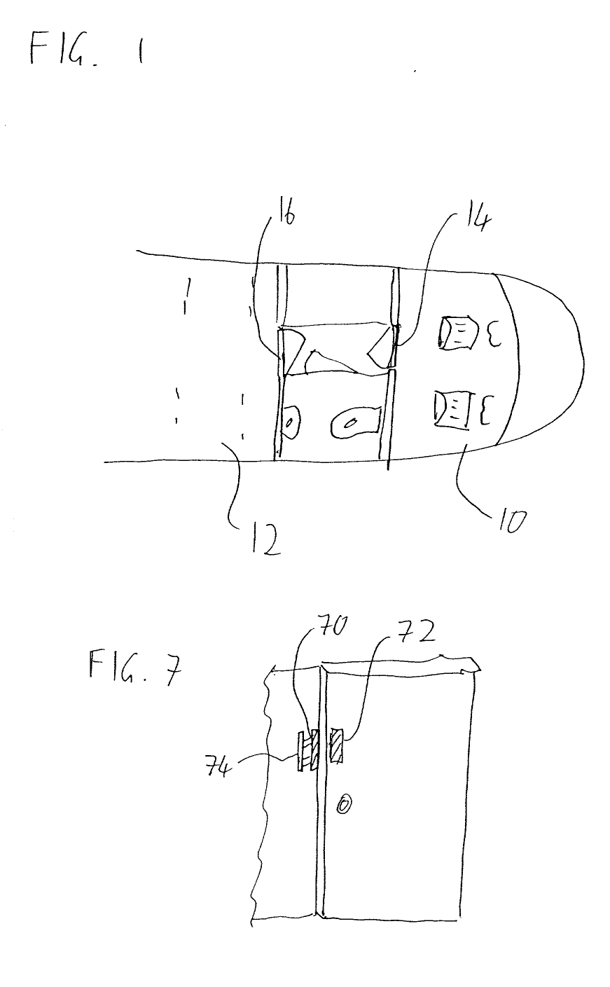

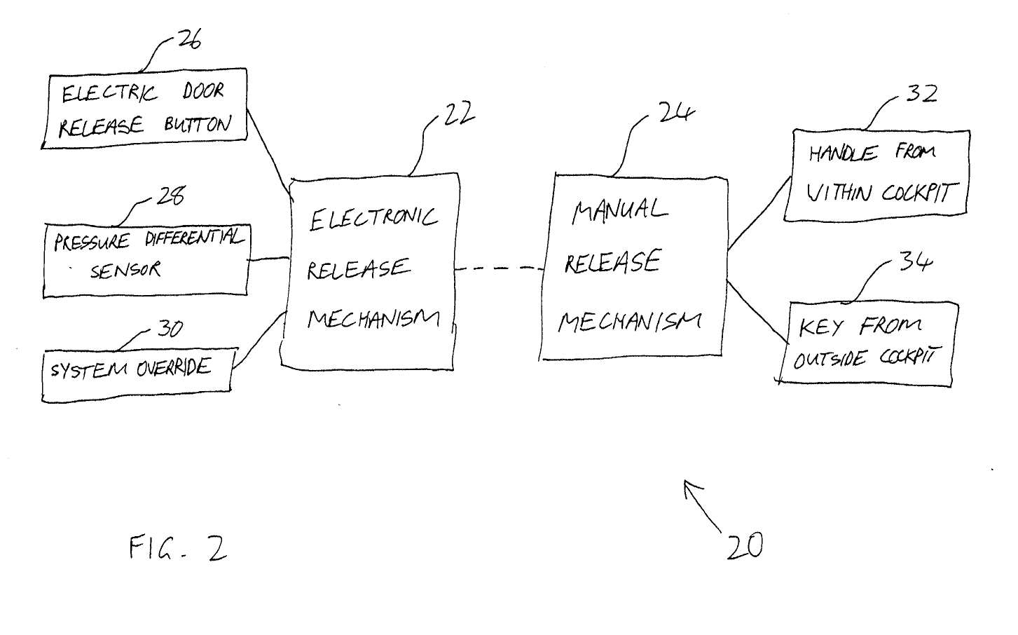

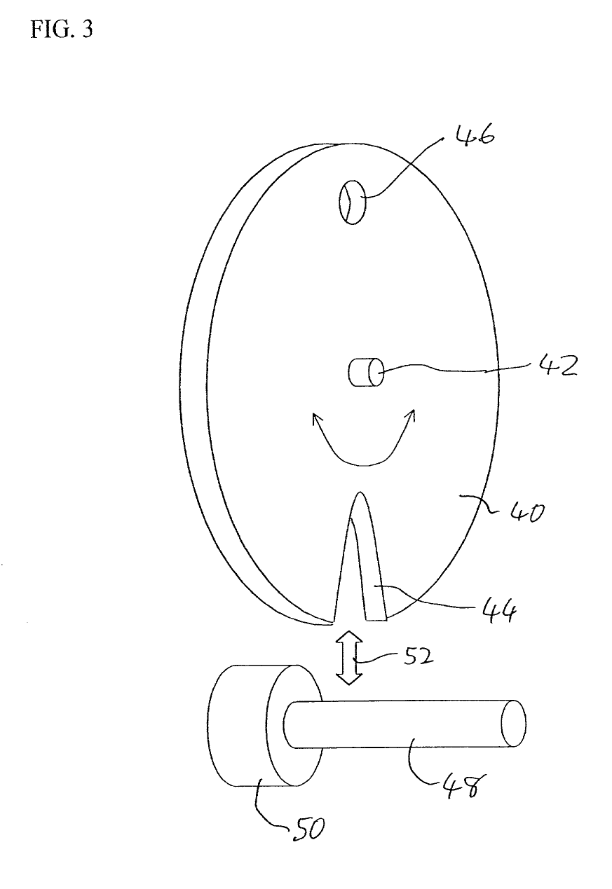

The mechanical principles of a first preferred dual implementation are illustrated in FIG. 3. Specifically, there is shown a locking disc 40 rotatably mounted about an axis 42 fixed to the doorframe. Locking disc 40 features a peripheral slot 44 and has a hole 46 for receiving a pin (not shown here) to selectively fix disc 40 against rotation. A bolt 48 having a wide end portion 50 is supported by a manual lock mechanism in the door. Bolt 48 is selectively displaceable relative to axis 42 along a direction 52 so as to be selectively engaged within slot 44.

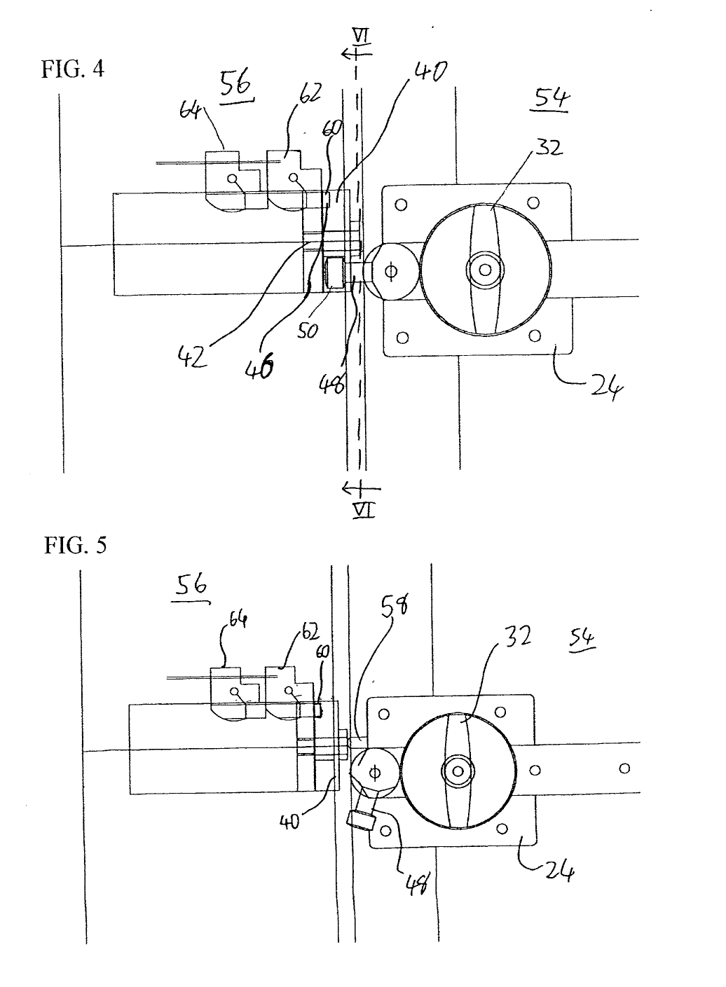

FIGS. 4-6 show a specific implementation of this structure relative to a door 54 and doorframe 56. Here, manual release mechanism 24 in door 54 may be operated by handle 32, or by a key from the opposite side, to move bolt 48 in an arcuate motion from the state of FIG. 4 to an open position shown in FIG. 5, thereby disengaging bolt 48 from slot 44 and allowing the door to be opened.

Preferably, mechanism 24 is provided with a double latch mechanism, which retains bolt 48 in its open position while the door is open and then automatically releases the bolt to return, under action of a spring, to its locked state when the door is closed (typically triggered by a trigger button 58 as seen in FIG. 5). Additionally, the same, or a different, latch mechanism is preferably configured to retain bolt 48 in its locked position until manual mechanism 24 is operated, thereby providing a securely locked configuration. Further details of the latch mechanisms are not shown but will be readily understood to one ordinarily skilled in the art from the functions described.

Also shown in FIGS. 4 and 5 are a pin 60, spring biased to engage hole 46, and solenoids 62 and 64 deployed to selectively withdraw pin 60 so as to free disc 40 to rotate. Solenoid 62 typically operates alone to provide the electric door release in response to button 26. One or both of pressure differential sensor 28 and system override 30 preferably actuate both solenoids 62 and 64 so as to provide an additional level of redundant failsafe operation for emergency situations.

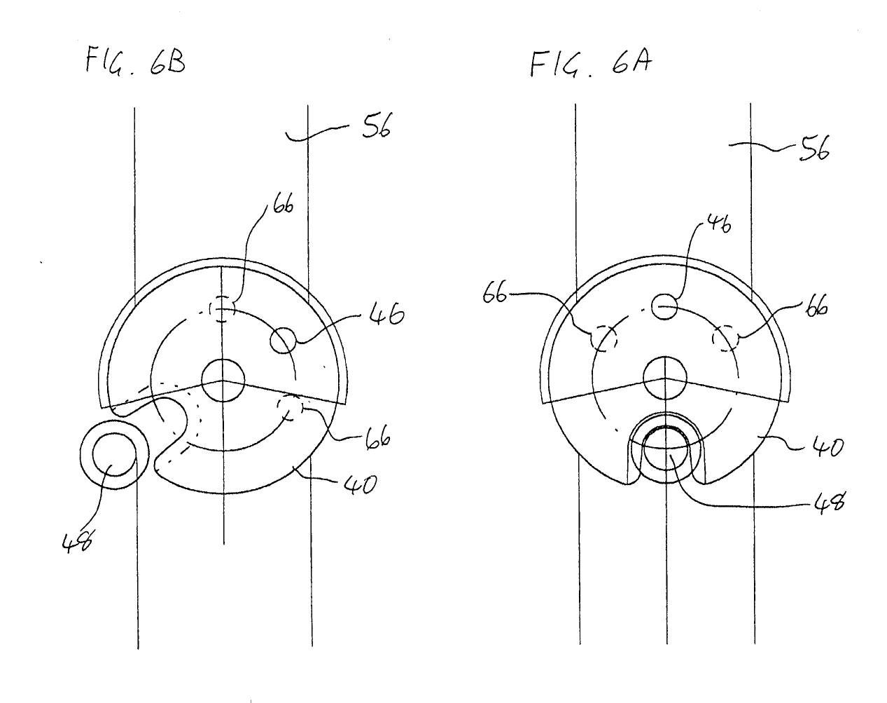

The operation of the electronic release system 22 is illustrated in FIGS. 6A and 6B. When one or both of the solenoids are actuated, pin 60 is temporarily withdrawn from hole 46 so as to free disc 40 to rotate. In this state, the door may be opened by a member of staff pushing against it, thereby forcing bolt 48 sideways and rotating disc 40 from the position of FIG. 6A to that of FIG. 6B. Disc 40 is then temporarily retained in this open position by the spring biasing of pin 60 which “clicks” into a slight depression 66. When the door is closed, bolt 48 catches in slot 44, forcing disc 40 back to its locked position where pin 60 springs back into engagement with hole 46, re-locking the door.

It will be noted that the releasing action of disc 40 is symmetrical, such that operation of electronic release system 22 is bi-directional, as required by the aforementioned safety directives relating to conditions of pressure differential.

It will also be noted that the system ensures that the door is locked whenever it is closed since both release mechanisms return naturally to their locked state each time the door is closed, or if actuated and released without the door being opened.

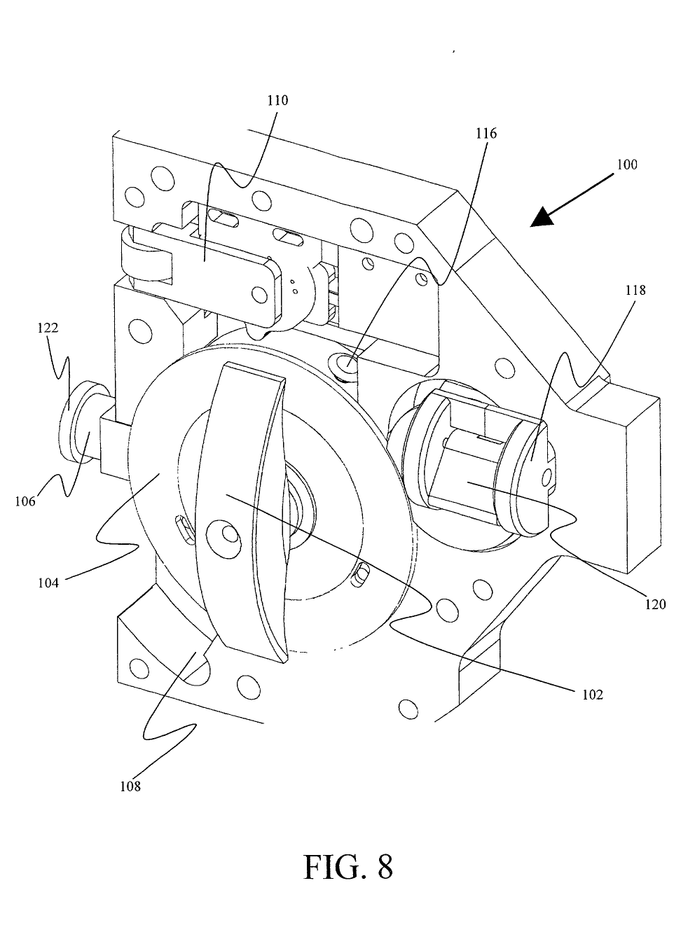

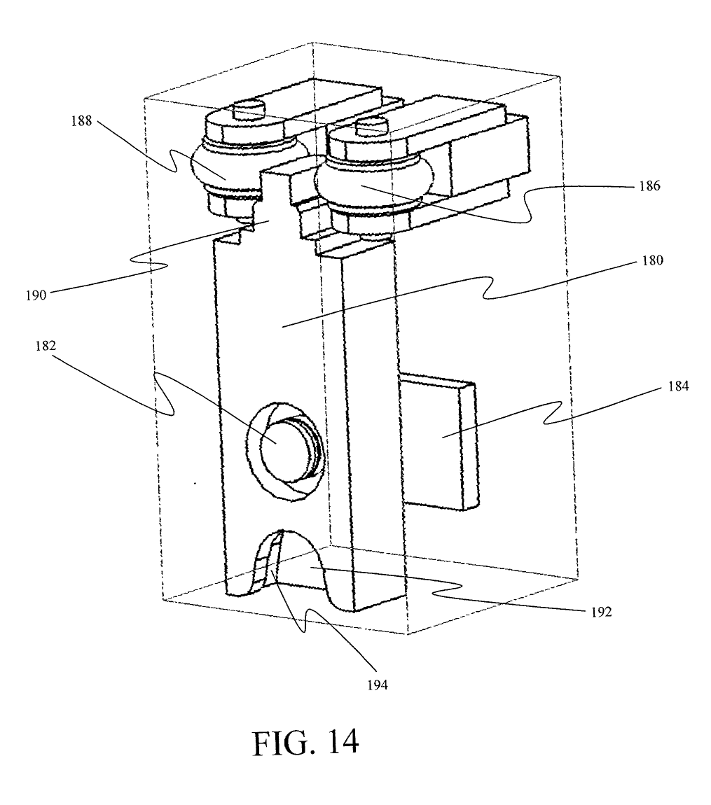

The mechanical principles of a second preferred implementation are illustrated in FIGS. 8-17, FIGS. 8-13 deal with the door mounted housing and FIGS. 14-17 deal with the doorframe mounted housing. Here too, the discussion will be directed toward restricting access to an aircraft cockpit, although this preferred embodiment may equally be applied to a range of other applications. Herein, the use of the directional terms clock wise and counter-clock wise are intended solely for the ease of discussion of the elements of the embodiments as oriented in the figures as shown, and no limitations are intended by use of these terms.

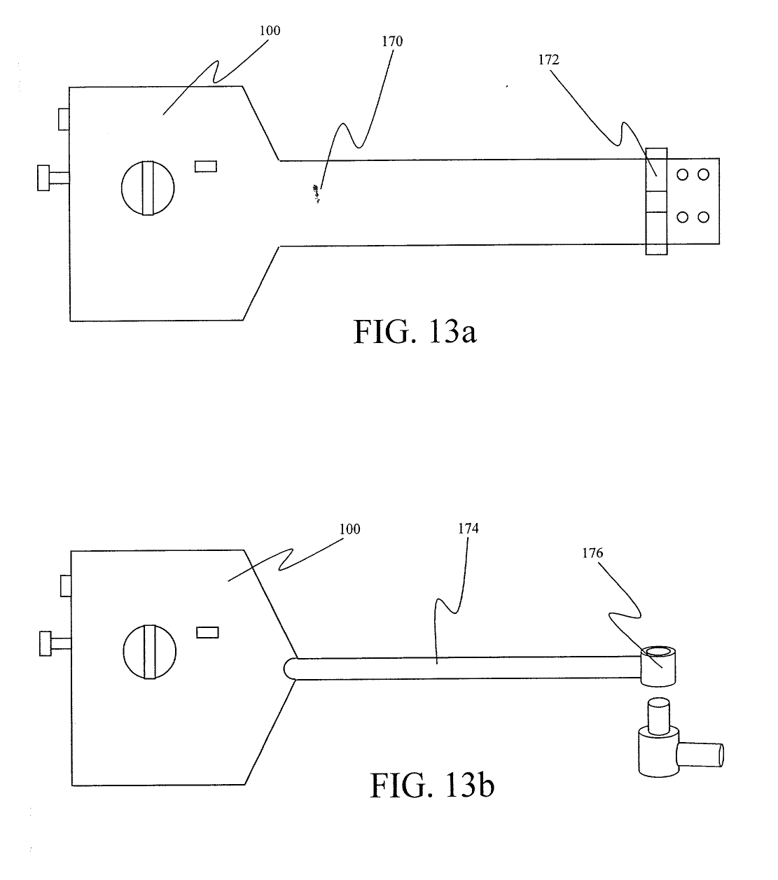

Specifically shown in FIG. 8 is a preferred embodiment of a door mounted housing 100, constructed and operative according to the teachings of the present invention. Here, the view is from the cockpit side of the door, and the mechanism is shown in its normally locked state. As the handle 102 is rotated in a counter clock-wise direction, the disk 104, which is spring biased to automatically rotate in a clock wise direction, also rotates in a counter-clock wise direction, thereby bring the locking bolt 106 to an unlocked deployment at position 108. Note the enlarged tip 122 of the bolt. The enlarged tip may be implemented as a perpendicular enlargement of the bolt, as shown here, or as any other configuration, such as but not limited to a flared tip, a spherical tip, or a “mushroom” shaped tip. The corresponding bolt-receiver (discussed further in FIG. 13) is configured with a corresponding groove that holds the bolt in place restricting any lateral movement intended to pull the bolt out of the receiver. This lateral movement is further restricted by a security bar (discussed further in FIGS. 13a and 13b) that extends from the housing to the hinge edge of the door and is further interconnected to the doorframe. Rotation of the disk 104, and thereby unlocking of the door, from the other side of the door is accomplished by rotation of a keyed cylinder (not shown). A key-cylinder-rotation disabling mechanism 118 is located directly opposite the keyed cylinder, on the cockpit side of the door. There are many ways a disabling mechanism may be configured, discussed here are two. In a first configuration it may render the mechanism such that operation of the activator, in this case the key, has no affect on the rest of the mechanism. In a second configuration, it may simply restrict operation of the activator. In the example shown here, the second configuration is used, and lever 120 selectively allows or restricts rotation of the key rotation mechanism. Also shown here are a bolt-retaining latch mechanism 110, and a rotation restriction pin 116.

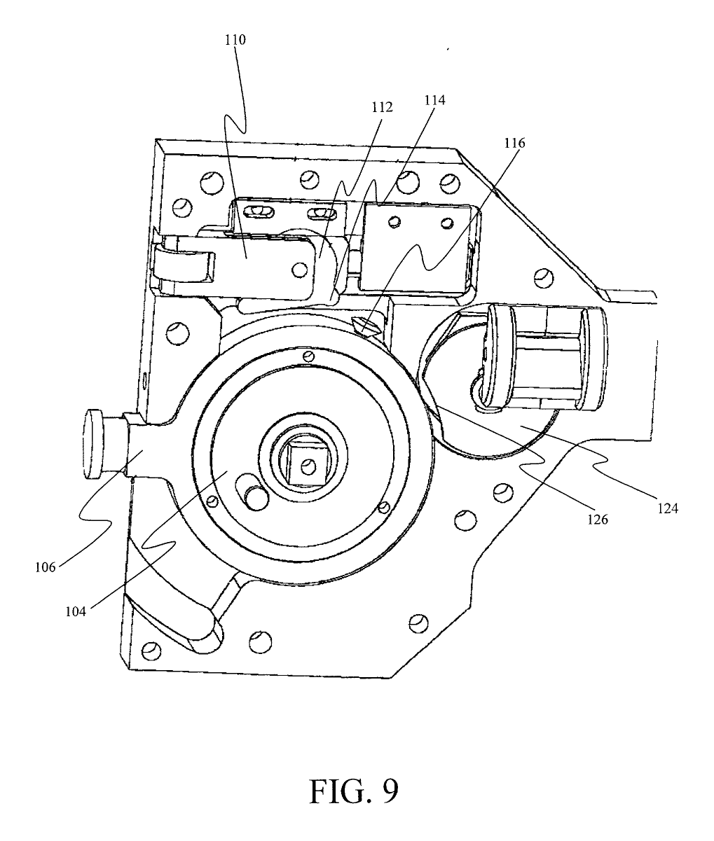

The perspective of FIG. 9 gives a better view of some of the features discussed above. Here, shown in a closed door state, bolt-retaining latch 110 is deployed such that latch cam 112 is rotated with knob 114 away from pin 116 so as not to restrict rotation of disk 104. The relationship between the disk 104 and the locking bolt 106 may also be appreciated. When the keyed cylinder (not shown) on the opposite side of the door is rotated, the gear 124 also rotates, thereby engaging teeth on the edge of disk 104 and rotating the bolt to an unlocked position. The gear 124 is cutout along portion 126 of its circumference prevent intermeshing with of disk 104 when the key rotation mechanism is not in use.

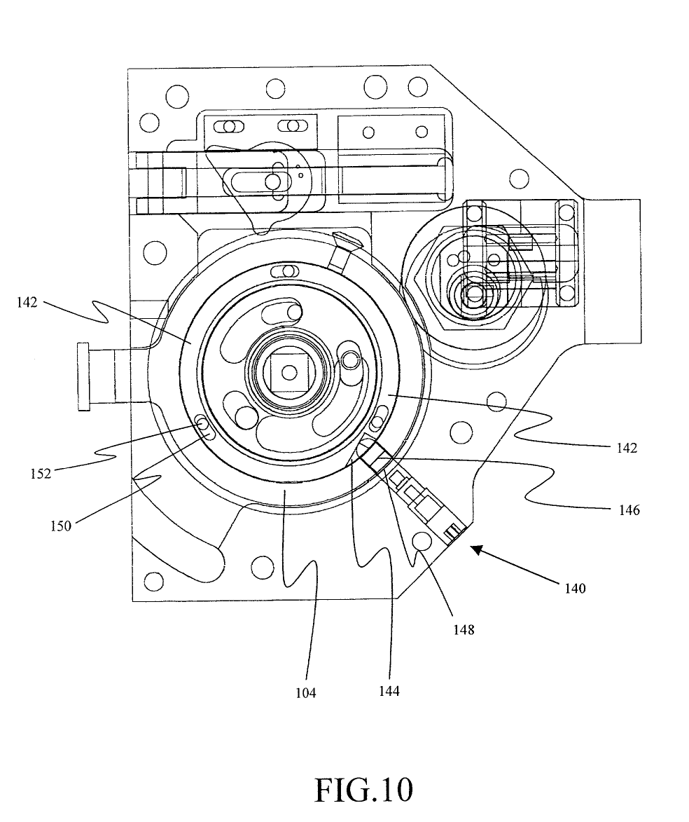

Of interest in FIG. 10 is the operation of a rotation locking-pin 140. When in the normally locked state, spring biased locking-pin 140 engages locking notch 144, thereby restricting rotation of disk 104 out of the locked position. Disk 142 may be rotated by either the handle on the cockpit side of the door or the key rotation mechanism on the cabin side of the door. When disk 142 is rotated in a counter-clock wise direction, the head of locking-pin 140 is pushed out of notch 144 by the slope of the notch in that direction. The head portion of the locking-pin is separate from the rest of the locking-pin along line 146, so that when line 146 is aligned with the edge 148 of disk 104, disk 104 is free to rotate. Rotation of disk 104 is accomplished by engagement of pins 152 with the ends of slots 150. That is to say, when disk 104 is held in a normally locked state by locking-pin 140, disk 142 is free to rotate with the degree of freedom provided by slots 150. Once disk 142 has rotated counter-clock wise far enough to move the locking-pin to a point that will allow rotation of disk 104, the ends of the slots 150 in disk 142 will engage pins 152 attached to disk 104, thereby beginning rotation of disk 104.

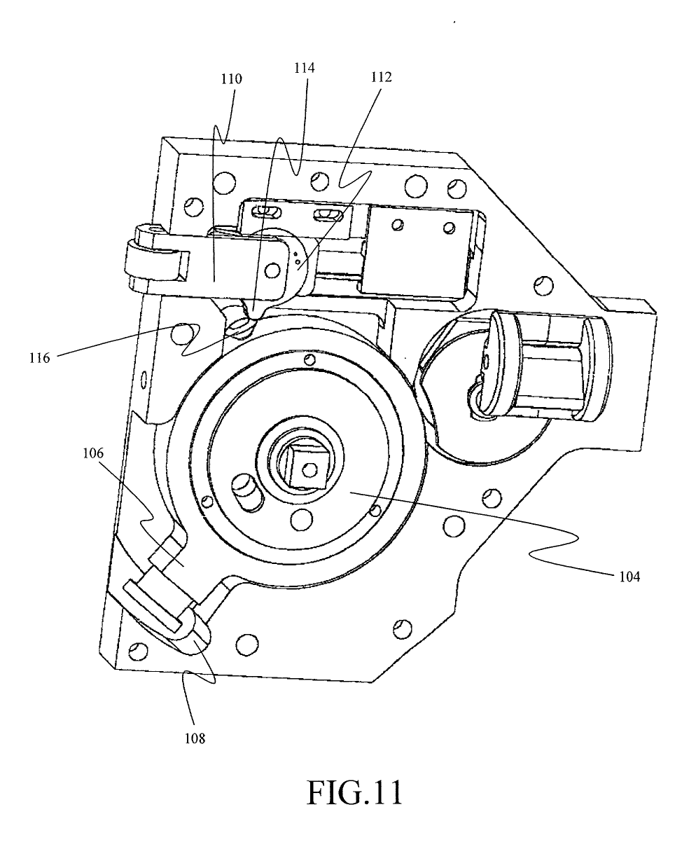

In FIG. 11, the mechanism is shown in an unlocked state, as if the door were open. Disk 104 has been rotated to bring bolt 106 to an unlocked position at 108. With the door open, the spring biased bolt-retaining latch 110 moves to an open door deployment shown here, thereby rotating the latch cam 112 and bringing knob 114 into contact with the rotation restriction pin 116. This deployment will keep disk 104 from rotating back to the normally locked state. Closure of the door will bring the bolt-retaining latch into contact with the doorframe, thereby forcing the bolt-retaining latch back into the housing and to its closed door state, which will move knob 114 away from the rotation restriction pin 116. Disk 104 will then be free to return to normally locked position.

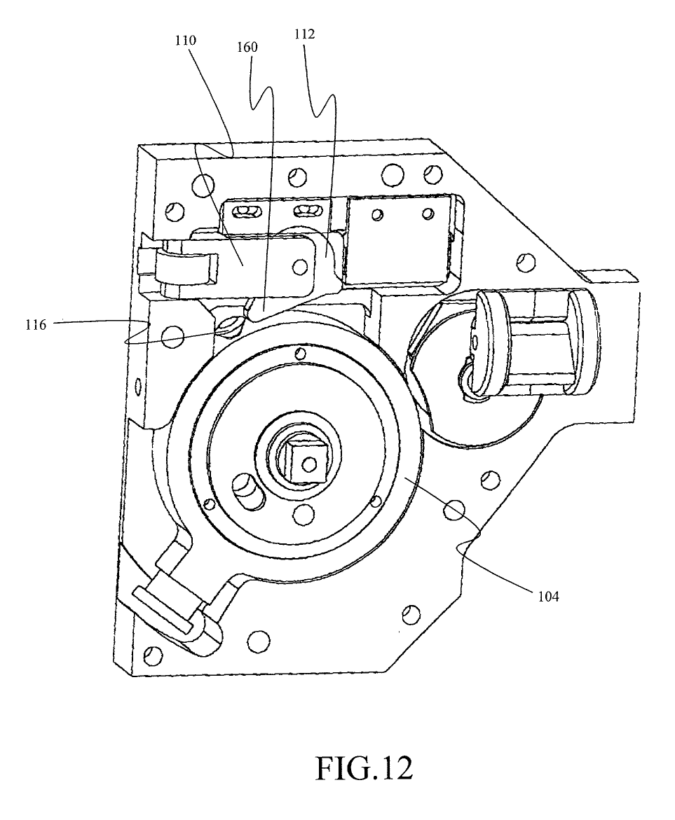

FIG. 12 shows a third deployment position of the bolt-retaining latch. There are times when it may be desirable to have the door unlocked and free to be opened or closed at will, thereby allow unrestricted passage between the cockpit and the cabin, such as during routine servicing of the aircraft. When this is desired, the bolt-retaining latch 110 may be pressed, by for example a thumb or finger, back into the housing past the closed door state while disk 104 is held in the unlocked position. release of the bolt-retaining latch allows it to move slightly toward the closed door state thereby bring knob 160 into contact with the rotation restriction pin 116 thus holding the mechanism in an always unlocked state. This restriction of the rotation of disk 104 may be accomplished in other ways, such as but not limited to, a pin inserted into a hole in the side of the disk, a rotatable element that selectively engages an notch in the disk either in the side or along the circumference.

FIGS. 13a and 13b show two preferred embodiments of security bars constructed and operative according to the teachings of the present invention. In both embodiments, the security bar extends from the door mounted housing 100 to a hinge located on the hinge edge of the door. The embodiment of FIG. 13a is a non-limiting example of a combination of a flat bar 170 and a piano hinge 172. The non-limiting example of FIG. 13b is a combination of a round bar, or pipe, 174 and a single barrel and pin hinge 176. As mentioned above, when the door is closed and locked, the security bar provides a substantially continuous barrier across the full width of the doorframe.

Turning now to the doorframe mounted housing, it should be noted that the term “doorframe” as used herein is intended to refer any structure to which the door and other components of the present invention may be attached. That is to say, the “doorframe” may be a distinct frame set into the passageway, it may be the surfaces of the passageway, or a combination of the two. FIG. 14 shows a detail of the bolt-receiver 180 and the rotatable wheel elements 186 and 188 that control rotation of the bolt-receiver. As shown here, the wheel elements are blocking the movement of the upper extension 190 of the bolt-receiver, thereby restricting rotation of the bolt-receiver. When either or both of the wheel elements are moved away from the upper extension, the bolt-receiver is free to rotate about pin 182. Thus, if wheel 188 is located of the cockpit side of the door, by moving it away from the upper extension 190 the bolt-receiver will be free to rotate counter-clock wise, thereby opening the door toward the cabin of the aircraft. Likewise, if wheel 186 is move away, the bolt-receiver will be free to rotate clock wise, thereby releasing the bolt and opening the door toward the cockpit of the aircraft. The pin 182 is anchored to the doorframe by mounting plate 184. When in the normally locked state shown here, the bolt from the door mounted housing will engage the bolt-receiver by arching up into the receiver slot 192. Note that the enlarged tip of the bolt fits into the groove 194 in the receiver slot. This combination of enlarged tip and groove provides an interlocked state that will hold the bolt in the bolt-receiver against lateral forces, such as if the door is exposed to forces that will cause the door to bend, for example if a terrorist were trying to force the cockpit door open.

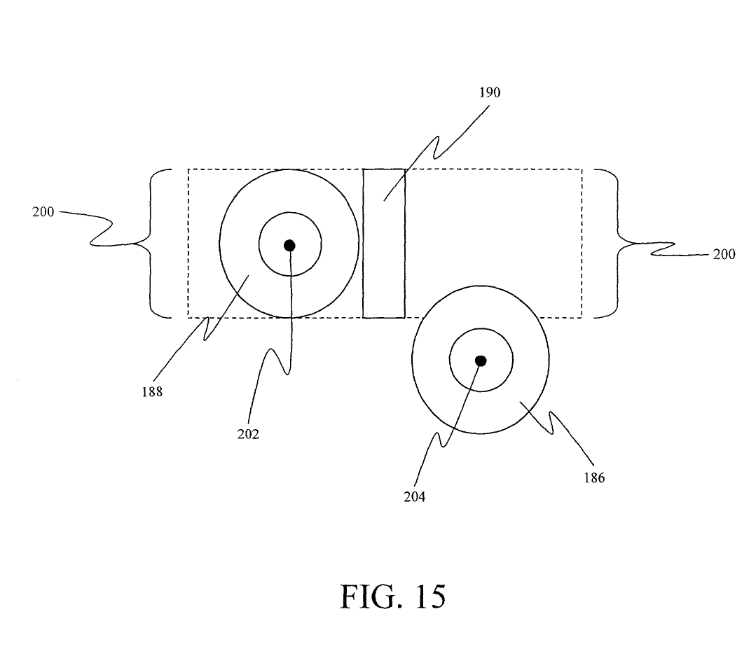

The schematic view of FIG. 15 shows the basic principles of the release mechanism used to restrict the rotation of the bolt-receiver. When the bolt-receiver is free to rotate, the upper extension 190 travels with in a predetermined path 200. If the path is blocked the bolt-receiver can not rotate and conversely if the path is not blocked the bolt-receiver is free to rotate. A device not using rotatable elements to block movement of the upper extension, under normal operating conditions, would simply move one or both of the non-rotatable blocks out of the path of the upper extension, and the bolt-receiver would be free to rotate and release the bolt. In some situations, the upper extension may bring extreme force to bare against the non-rotatable blocks. The friction created by this extreme force could prove difficult or impossible to overcome, thereby holding the door closed at a time when it must be opened, such as a sudden change in cabin or cockpit air-pressure. A feature of the present invention is the use of rotatable elements with a substantially circular cross-section to block the path of the upper extension. Here, by non-limiting example, the rotatable elements used are wheels. The axis of rotation of each of the wheels is substantially perpendicular to the direction of movement of the upper extension and substantially parallel to a radius of the circle of rotation represented by a center-line of the bolt-receiver when the bolt-receiver is in the normally locked state. Since, under normal operating conditions, there is substantially no force brought against the wheel by the upper extension, there is substantially little or no friction between the wheel and the upper extension that will interfere with the movement of the wheel to a non-blocking position. In some extraordinary situations, however, the upper extension may bring extreme force against the wheel. If the axis of rotation of the wheel is inside the path of the upper extension as illustrated by wheel 188 with an axis of rotation 202, any force brought against the wheel by the upper extension will be met with total resistance. This is representative of a situation where it is desirable for the door to remain closed and locked, such as a terrorist attempt to enter the cockpit. As soon as the axis of rotation of the wheel moves outside the path of the upper extension as illustrated by wheel 186 with an axis of rotation 204, any force brought against the wheel by the upper extension will cause the wheel to rotate and the axis of rotation, and thereby the wheel, is pushed further out of the path of the upper extension 190, thus helping rather than hindering the movement of the blocking element. This is representative of a situation where it is desirable for the door to open quickly and substantially unrestricted, such as in the case of sudden lost of air-pressure on only one side of the door. It should be noted that this feature of the present invention can be easily adapted to numerous applications where the force of opening a door may create friction or other forces that may restrict the opening of the door, such as but not limited to, building emergency or fire exits. That is to say, that the discussion here could describe element 190, here referred to as the upper extension of the bolt-receiver, as, by way of non-limiting example ,a door mounted bolt, or as a door itself. It is further conceivable that the rotatable elements may be located on the door and element 190 may be either displaceablely or fixedly attached to the doorframe.

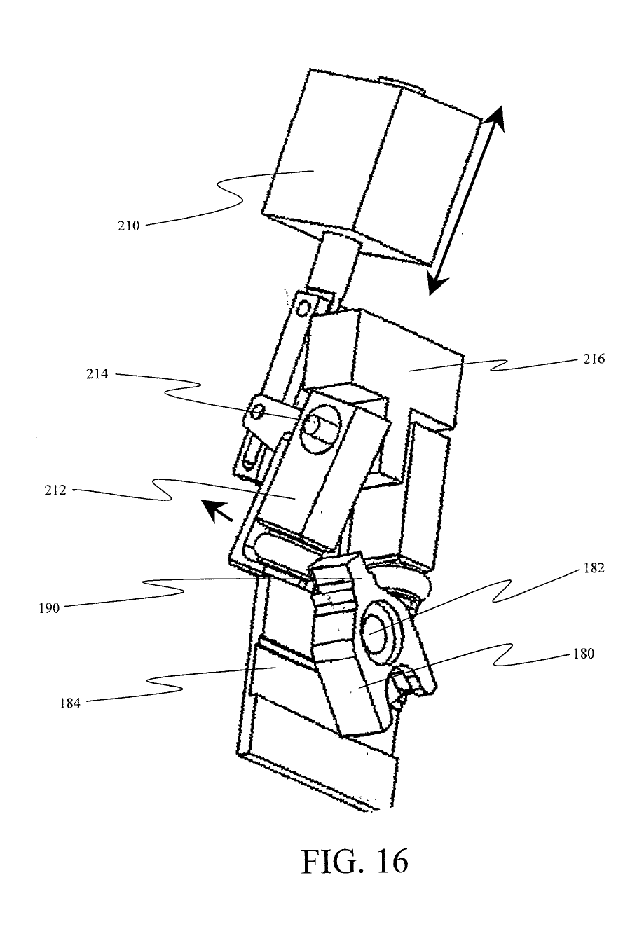

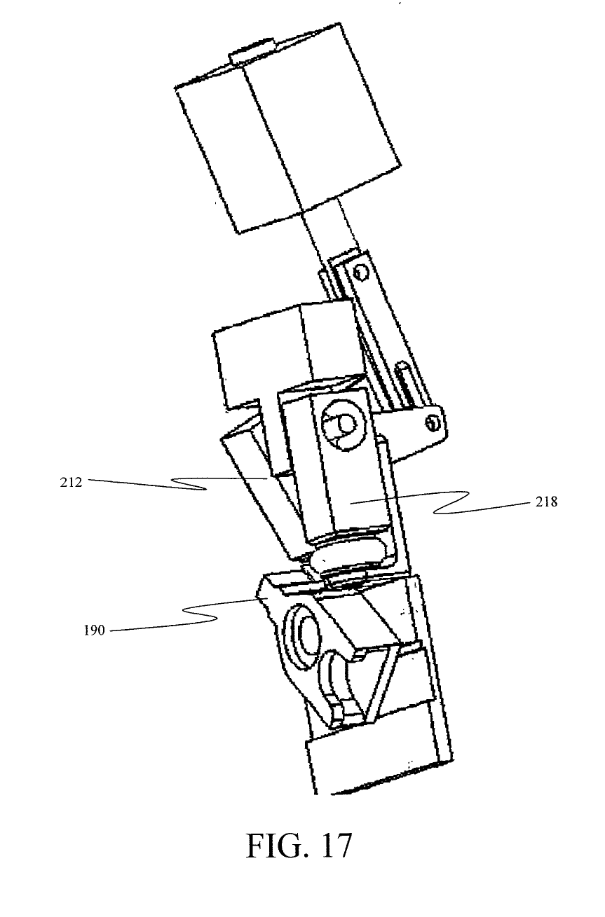

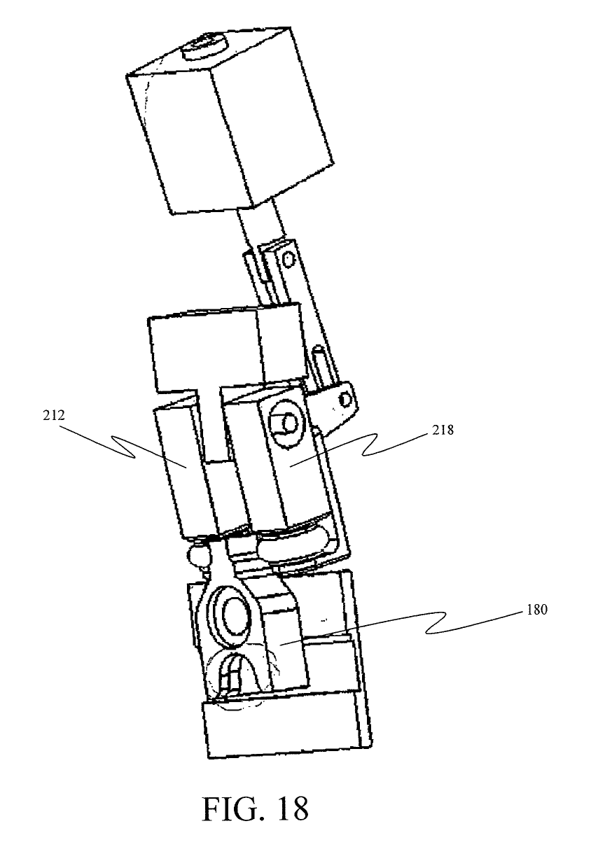

FIGS. 16 and 17 are different perspective views of a preferred embodiment of an electromagnetic device that controls the movement of the wheel elements between the normally locked state, restricting rotation of the bolt-receiver and the unlocked state allowing the bolt-receiver to rotate. The activation of the electromagnetic device may be by use of any of a number of actuators, such as but not limited to, a manually operated switch, a pressure monitoring system that monitors the atmospheric pressure on each side of the door, and a system override switch, all of which may be used individually or in any combination. Each wheel element is associated with at least one such electromagnetic device, however, this discussion will be limited a single device for the sake of brevity. The movement of element 210, as illustrated in FIG. 16, is actuated electromagnetically. The element itself my be a metallic mass in close proximity to an electromagnet, or the element may be an electromagnet in close proximity to either a metallic mass or another electromagnet. When the electromagnetic element moves, here by non-limiting example the movement is substantially up and down, it causes the rotation of wheel element 212 about axis pin 214. Here, the non-limiting example is of rotation about an axis that is perpendicular to the axis of rotation of the bolt-receiver. This rotation of the wheel moves the wheel out of the normally locked state, thereby allowing the bolt-receiver 180 to rotate about pin 182 in a counter-clock wise direction, thus releasing the bolt and opening the door. It will be readily understood to one ordinarily skilled in the art, from the functions described, that there are numerous combinations of the direction of movement of the electromagnetic element and the rotation of the wheel element that will accomplish desired effect of moving the wheel out of the way of the upper extension of the bolt-receiver. Supporting element 216 may be mounted to the doorframe.

In FIG. 17, the wheel element 212 is rotated to the unlocked state and the bolt-receiver 180 has rotated releasing the bolt. A wheel element 218 located on the opposite side of the upper extension from wheel element 212 has remained in the normally locked state, thereby acting as a bumper for the bolt-receiver when it is rotated back to its normally lock state.

It should be noted that the desired result of the actions of the electromagnet devices of FIGS. 16, 17, and 18 may also be achieved by use of other systems including electric motors or hydraulic systems.

It will be apparent to one normally skilled on the art that the operation of elements discussed in relation to FIGS. 16 and 17 may be applied to the operation of wheel element 218, thereby allowing the door to be opened in the opposite direction.

FIG. 18 illustrates a situation where both wheel elements 212 and 218 are rotated to the unlocked state thereby allowing the bolt-receiver to rotate freely in either direction as necessary. This may be advantageous in the case of sudden pressure drop, or during routine aircraft servicing.

It will be appreciated that the above descriptions are intended only to serve as examples, and that many other embodiments are possible within the spirit and the scope of the present invention.

What is claimed is:

1. A lockable doorway system, comprising:
(a) a doorframe, having a height and a width;
(b) a door, an edge of said door being hingedly connected to said doorframe;
(c) a door mounted bolt mechanism including a displaceable locking bolt; and
(d) a doorframe mounted bolt-receiver;
wherein said bolt, and said bolt-receiver are configured such that in a locked state said bolt and said bolt-receiver are engaged, thereby interlocking said bolt in said bolt-receiver so as to retain said bolt in said bolt-receiver against forced removal of said bolt from said bolt-receiver along a vector away form said doorframe and toward said door, said vector being substantially parallel to said width.

2. The lockable doorway system of claim 1, wherein said bolt mechanism includes a spring biased rotatable disk, said rotatable disk having an axis that is substantially perpendicular to a plane of a surface of said door, with said bolt extending radially from said disk, whereby rotation of said disk, so as to bring said bolt to a disengaged position, is in a direction that further tensions said spring, and said bolt is displaceable along an arched path.

3. The lockable doorway system of claim 2, wherein said bolt includes an enlarged tip.

4. The lockable doorway system of claim 3, wherein said bolt-receiver includes a receiving slot configured to receive said bolt thereby trapping said enlarged tip.

5. The lockable doorway system of claim 1, wherein said bolt mechanism includes: a first bolt-actuator located on a first side of the door, said first bolt-actuator being deployed such that activation of said first bolt-actuator brings said bolt mechanism to an unlocked state; a second bolt-actuator located on a second side of the door; said second bolt-actuator being deployed such that activation of said second bolt-actuator brings said bolt mechanism to an unlocked state; and a disabling mechanism deployed so as to, when activated, disable said second-bolt-actuator, said disabling mechanism being accessible only from said first side of the door.

6. The lockable doorway system of claim 5, wherein said second bolt-actuator further includes a secondary-actuator mechanism that, when activated, engages said bolt mechanism.

7. The lockable doorway system of claim 1, wherein said bolt mechanism includes a latch mechanism whereby said displacement of said bolt may selectively be restricted.

8. The lockable doorway system of claim 1, further comprising a security bar that extends from said bolt mechanism to said hinged edge of said door, said security bar being anchored to said doorframe at a hinged side of said doorframe.

9. The lockable doorway system of claim 8, wherein said security bar includes hinges thereby being hingedly attached to said doorframe.

10. A lockable doorway system, comprising:
(a) a doorframe, having a height and a width;
(b) a door, an edge of said door being hingedly connected to said doorframe so as to allow said door to open bi-directionally;
(c) a door mounted bolt mechanism including a displaceable locking bolt; and
(d) a doorframe mounted bolt-receiver having at least a first receiver-position wherein said bolt may be engaged, thereby holding the door in a locked position; said bolt-receiver being selectively releasable from said first receiver-position thereby allowing redeployment of said bolt-receiver so as to release said bolt thereby allowing said door to open in one of at least two modes, a first of said at least two modes allowing said door to open in one direction, a second of said at least two modes allowing said door to open in two directions;
wherein the door may be opened by both said displacement of the bolt and said redeployment of said bolt-receiver, each of said displacement of said bolt and said redeployment of said bolt receiver independently opening said door.

11. The lockable doorway system of claim 10, wherein said redeployment of said bolt-receiver includes rotation of said bolt-receiver about an axis that is substantially parallel to said width.

12. A lockable doorway system, comprising:
(a) a doorframe, having a height and a width;
(b) a door, an edge of said door being hingedly connected to said doorframe so as to allow said door to open bi-directionally;
(c) a door mounted bolt mechanism including a displaceable locking bolt;
(d) a doorframe mounted bolt-receiver, said bolt-receiver being mounted to the doorframe so as to be rotatable about an axis that is substantially parallel to said width, said bolt-receiver including at least a first receiver-position wherein said bolt may be engaged, thereby holding the door in a locked position; said bolt-receiver being selectively releasable from said first receiver-position thereby allowing redeployment of said bolt-receiver so as to release said bolt thereby allowing said door to open in one of at least two modes, a first of said at least two modes allowing said door to open in one direction, a second of said at least two modes allowing said door to open in two directions; and
(e) a release system for the selective release of said bolt-receiver.

13. A release system for selective release of a door from a locked position in a doorframe, the lock system comprising:
(a) an abutment portion of an element that is displaceable along a predetermined path when the door is opened; and
(b) a release mechanism deployed so as to retain the door in a locked state and when said release mechanism is activated the door is released from said locked state, said release mechanism including at least one rotatable element, said rotatable element having an axis of rotation, a cross-section of said rotatable element taken along a line substantially perpendicular to said axis of rotation is substantially circular, said rotatable element having at least two selectable deployment-positions including a first deployment-position wherein said axis of rotation of said rotatable element is within said displacement path of said abutment portion, thereby restricting said displacement of said abutment portion, and a second deployment-position wherein said axis of rotation of said rotatable element is outside said displacement path of said abutment portion, thereby allowing said displacement of said abutment portion.

14. The lock system of claim 13, wherein said abutment portion includes at least one from the following group:
(a) an extension of a rotatable bolt-receiver;
(b) the door;
(c) an extension of the door; and
(d) a displaceable lock bolt deployed in the door.

15. The lock system of claim 13, wherein said at least one rotatable element is implemented as at least two rotatable elements, deployment of a first of said at least two rotatable elements to its said second deployment-position allows displacement of said door element in a first direction, and deployment of a second of at least two rotatable elements to its said second deployment-position allows displacement of said door element in a second direction, said at least two rotatable elements being deployable individually or in combination.

16. The lock system of claim 13, wherein said release mechanism includes an electrically activated mechanism.

17. The lock system of claim 16, wherein said release mechanism includes at least one electromagnetic device for each of said rotatable elements such that each of said rotatable elements is deployed to any one of said deployment-positions by a corresponding said electromagnetic device.

18. The lock system of claim 17, wherein said electrical activation includes use of any devices, singularly and in combination, from a list including:
(a) a manually operated switch;
(b) a pressure monitoring system that monitors the atmospheric pressure on each side of the door; and
(c) a system override switch.
